(19) United States
(12) Patent Application Publication
(10) Pub. No.: US 2025/0349990 A1
(43) Pub. Date: Nov. 13, 2025

(54) ELECTRODE TAB, ELECTRODE ASSEMBLY, AND SECONDARY BATTERY

(71) Applicant: SAMSUNG SDI CO., LTD., Yongin-si (KR)

(72) Inventors: Kyugil CHOI, Yongin-si (KR); Byeongryeol LEE, Yongin-si (KR); Hyunju KIM, Yongin-si (KR); Dukju HAN, Yongin-si (KR); Hyunjin HWANG, Yongin-si (KR)

(21) Appl. No.: 18/941,068

(22) Filed: Nov. 8, 2024

(30) Foreign Application Priority Data
May 9, 2024 (KR) 10-2024-0061317

(51) Int. Cl. H01M 50/533; H01M 50/105; H01M 50/538

(52) U.S. Cl. CPC H01M 50/533; H01M 50/105; H01M 50/538

(57) ABSTRACT

An electrode tab includes uncoated regions stacked in a vertical direction, each of the multiple uncoated regions including an insulating layer and a metal layer disposed on at least one of an upper surface and a lower surface of the insulating layer. A conductive layer is disposed between each two adjacent uncoated regions of the multiple uncoated regions, and a conductive strip member that surrounds the stacked uncoated regions and the conductive layer. The conductive strip member is electrically connected to the conductive layer.

### CROSS-REFERENCE TO RELATED APPLICATION

This application claims priority under 35 U.S.C. § 119 to Korean Patent Application No. 10-2024-0061317, filed in the Korean Intellectual Property Office on May 9, 2024, the entire contents of which are hereby incorporated by reference.

### BACKGROUND

### Field

Aspects of embodiments of the present disclosure relate to an electrode tab of a secondary battery.

### Description of the Related Art

A region on an electrode substrate of a battery cell that is not coated with an electrode active material is referred to as an uncoated region, and an electrode tab is connected to the uncoated region to connect the electrode tab to an external electrode terminal. Because the electrode substrate is made of a metal and, thus, is heavy, a composite substrate has recently been used in which a part of a metal layer of the electrode substrate is replaced with an insulating layer made of lightweight materials such as polyethylene terephthalate (PET). However, problems may arise with such a composite substrate in that the metal layer on an upper surface of the insulating layer and the metal layer on a lower surface of the insulating layer may not by electrically conductive due to the presence of the insulating layer and electrical conduction between composite substrates may not be made.

The above information disclosed in this Background section is for enhancement of understanding of the background of the present disclosure, and therefore, it may contain information that does not constitute related (or prior) art.

### SUMMARY

Embodiments of the present disclosure provide an electrode tab, an electrode assembly, and a secondary battery including the same to resolve the aforementioned problems.

These and other aspects and features of the present disclosure will be described in or will be apparent from the following description of embodiments of the present disclosure.

According to embodiments of the present disclosure, an electrode tab may include uncoated regions stacked in a vertical direction, each of the uncoated regions including an insulating layer and a metal layer disposed on at least one of an upper surface and a lower surface of the insulating layer, a conductive layer disposed between each two adjacent uncoated regions of the uncoated regions, and a conductive strip member that surrounds the stacked uncoated regions and the conductive layer, with the conductive strip member being electrically connected to the conductive layer.

According to some embodiments, the conductive layer includes a protrusion extending beyond a side surface of an adjacent uncoated region, with the protrusion contacting the conductive strip member.

According to some embodiments, the protrusion covers at least one side surface of an adjacent upper uncoated region and an adjacent lower uncoated region.

According to some embodiments, the conductive layer includes a conductive tape.

According to some embodiments, the conductive layer includes a conductive paste.

According to some embodiments, the conductive strip member is in contact with an upper surface of a first uncoated region disposed at the uppermost position of the multiple uncoated regions, a lower surface of a second uncoated region disposed at the lowermost position of the multiple uncoated regions, and the protrusion of the conductive layer.

According to some embodiments, the electrode tab further includes a strip terminal coupled to an upper surface or a lower surface of the conductive strip member.

According to some embodiments, the conductive strip member includes a body portion that surrounds the multiple uncoated regions and the conductive layer, and a connection portion extending from the body portion.

According to some embodiments, the electrode tab further includes a strip terminal coupled to an upper surface or a lower surface of the connection portion.

According to some embodiments, the electrode tab further includes an air gap surrounded by an inner side of the conductive strip member, the uncoated region, and the protrusion.

According to further embodiments of the present disclosure, an electrode assembly may include a first electrode, a second electrode, a separator disposed between the first electrode and the second electrode, and an electrode tab coupled to one end of the first electrode. The electrode tab may include uncoated regions stacked in a vertical direction, each of the uncoated regions including an insulating layer and a metal layer disposed on at least one of an upper surface and a lower surface of the insulating layer, a conductive layer disposed between each of two adjacent uncoated regions of the uncoated regions, and a conductive strip member that surrounds the stacked uncoated regions and the conductive layer, with the conductive strip member being electrically connected to the conductive layer.

According to some embodiments, the conductive layer includes a protrusion extending beyond a side surface of an adjacent uncoated region, with the protrusion contacting the conductive strip member.

According to some embodiments, the protrusion covers at least one side surface of an adjacent upper uncoated region and an adjacent lower uncoated region.

According to some embodiments, the conductive layer includes a conductive tape.

According to some embodiments, the conductive layer includes a conductive paste.

According to some embodiments, the conductive strip member is in contact with an upper surface of a first uncoated region disposed at the uppermost position of the multiple uncoated regions, a lower surface of a second uncoated region disposed at the lowermost position of the multiple uncoated regions, and the protrusion of the conductive layer.

According to still further embodiments of the present disclosure, a secondary battery may include an electrode assembly, a case enclosing the electrode assembly, and an electrolyte impregnating the electrode assembly. The electrode assembly may include a first electrode, a second electrode disposed, a separator disposed between the first electrode and the second electrode, and an electrode tab coupled to one end of the first electrode. The electrode tab may include uncoated regions stacked in a vertical direction, with each of the uncoated regions including an insulating layer and a metal layer disposed on at least one of an upper surface and a lower surface of the insulating layer; a conductive layer disposed between each of two adjacent uncoated regions of the uncoated regions; and a conductive strip member that surrounds the stacked uncoated regions and the conductive layer, with the conductive strip member being electrically connected to the conductive layer.

According to some embodiments, the conductive layer includes a protrusion extending beyond a side surface of an adjacent uncoated region, with the protrusion contacting the conductive strip member.

According to some embodiments, the conductive layer includes a conductive tape or a conductive paste.

According to some embodiments, the conductive strip member is in contact with an upper surface of a first uncoated region disposed at the uppermost position of the multiple uncoated regions, a lower surface of a second uncoated region disposed at the lowermost position of the multiple uncoated regions, and the protrusion of the conductive layer.

According to some embodiments of the present disclosure, by utilizing the connection structure between the conductive layers disposed between the multiple uncoated regions and the conductive strip member, it is possible to facilitate electrical conduction between composite substrates.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 is a perspective view of a pouch-type secondary battery.

FIG. 2 illustrates an electrode tab using a conductive tape as a conductive layer according to an embodiment of the present disclosure.

FIG. 3 illustrates an electrode tab using a conductive paste as a conductive layer according to an embodiment of the present disclosure.

FIG. 4 schematically illustrates an uncoated region according to an embodiment of the present disclosure.

FIG. 5 illustrates stacked multiple uncoated regions with a conductive tape disposed between each of two adjacent uncoated regions according to an embodiment of the present disclosure.

FIG. 6a illustrates stacked multiple uncoated regions with a conductive paste applied between each of two adjacent uncoated regions according to an embodiment of the present disclosure.

FIG. 6b illustrates the result of pressing the uncoated regions after the conductive paste is applied between each of two adjacent uncoated regions of the stacked multiple uncoated regions according to an embodiment of the present disclosure.

FIG. 7 illustrates a conductive strip member before folding according to an embodiment of the present disclosure.

FIG. 8 illustrates a state where a strip terminal is connected to an upper surface of the conductive strip member according to an embodiment of the present disclosure.

FIG. 9 illustrates a state where a strip terminal is connected to a lower surface of the conductive strip member according to an embodiment of the present disclosure.

FIG. 10 illustrates a conductive strip member including a body portion and a connection portion before folding according to another embodiment of the present disclosure.

FIG. 11 illustrates a state where a strip terminal is connected to an upper surface of the connection portion of the conductive strip member according to an embodiment of the present disclosure.

FIG. 12 illustrates a state where a strip terminal is connected to a lower surface of the connection portion of the conductive strip member according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the scope of the disclosure.

Throughout this specification, exemplary embodiments of pouch batteries are described, but it will be understood that the present disclosure is not limited to pouch batteries and can be generally applied to all types of secondary batteries, including cylindrical, prismatic, and pouch batteries.

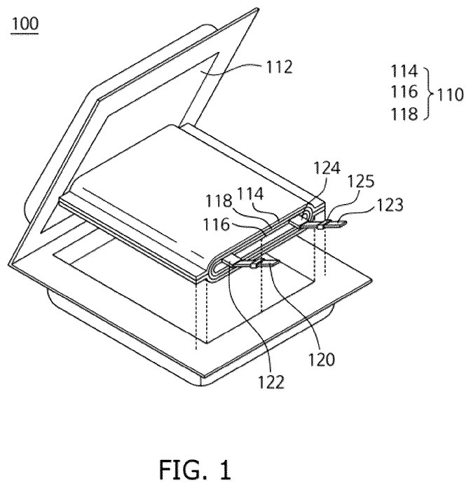

FIG. 1 is a perspective view of a pouch-type secondary battery.

As shown in FIG. 1, a secondary battery 100, which is in the form of a pouch battery, may include an electrode assembly 110, a case 112 enclosing the electrode assembly 110, and an electrolyte impregnating the electrode assembly 110.

The electrode assembly 110 may be formed by winding or stacking a first electrode 114, a separator 118, and a second electrode 116, which are formed in thin plates or films. In a case where the electrode assembly 110 is a wound stack, a winding axis may be parallel to a longitudinal direction of the case. Further, the electrode assembly may be a stack type rather than a winging type, and the present disclosure is not limit with respect to the shape of the electrode assembly. In some embodiments, the electrode assembly may be a Z-stack electrode assembly in which a positive electrode plate and a negative electrode plate are inserted to both sides of a separator folded in a Z-shape. Furthermore, one or more electrode assemblies may be stacked such that their long sides are adjacent to each other and housed within the case, and the number of electrode assemblies is not limited in the present disclosure. The first electrode 114 of the electrode assembly 110 may serve as a negative electrode, and the second electrode 116 may serve as the positive electrode. The opposite arrangement with the first electrode 114 being the positive electrode and the second electrode 116 being the negative electrode is also possible.

The first electrode plate may be formed by coating a first electrode current collector, which may be made of metal foil such as copper, copper alloy, nickel, or nickel alloy, with a first electrode active material such as graphite or carbon. The first electrode plate may include a first electrode tab, which is a region where the first electrode active material is not coated. The first electrode tab may serve as a pathway for current flow between the first electrode plate and the first current collector. In some embodiments, when the first electrode plate is manufactured, the first electrode tab may be formed by being cut to protrude to one side of the electrode assembly, or the first electrode tab may protrude to one side of the electrode assembly more than (e.g., farther than or beyond) the separator without being separately cut.

The second electrode plate is formed by coating a second electrode current collector, which is made of metal foil such as aluminum or aluminum alloy, with a second electrode active material such as a transition metal oxide. The second electrode plate may include a second electrode tab, which is a region where the second electrode active material is not coated. The second electrode tab may serve as a pathway for current flow between the second electrode plate and the second current collector. In some embodiments, the second electrode tab may be formed by being cut to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

In some examples, the first electrode tab may be located on the left side of the electrode assembly, and the second electrode tab may be located on the right side of the electrode assembly, or the first electrode tab and the second electrode tab may both be located on the same side. Here, “left side” and “right side” are the left side and the right side with respect to the secondary battery 100 shown in FIG. 1 for convenience of description, and the positions of the first electrode tab and the second electrode tab may be changed when the secondary battery is rotated horizontally or vertically.

The first electrode tab 122 of the first electrode plate and the second electrode tab 124 of the second electrode plate may be positioned at an end of the electrode assembly 110. In some examples, the electrode assembly 110 may be accommodated in the case together with the electrolyte. In addition, the first electrode tab 122 of the first electrode plate and the second electrode tab 124 of the second electrode plate, which are exposed at the end of the electrode assembly 110, may be connected to a first strip terminal 120 and a second strip terminal 123, respectively. As will be described below, the first strip terminal 120 and the second strip terminal 123 may be welded to conductive strip members of the first electrode tab 122 and the second electrode tab 124, respectively. Further, each of the first strip terminal 120 and the second strip terminal 123 may be provided with an insulating portion 125 for insulation from the case 112.

In the example shown in FIG. 1, the case 112 is illustrated as a pouch, but the case 112 may be configured in various shapes, such as a cylindrical shape, a prismatic shape, or the like. The case 112 may be made of a metallic material such as aluminum, aluminum alloy, nickel-plated steel, or the like. Alternatively, the case 112 may be made of a laminated film or plastic that forms the pouch.

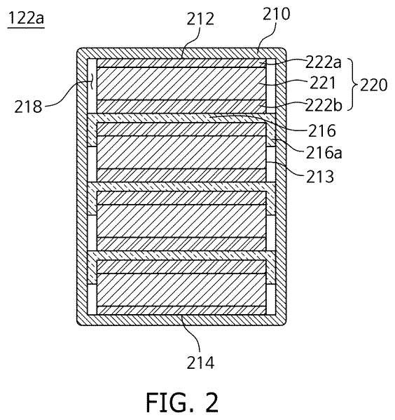

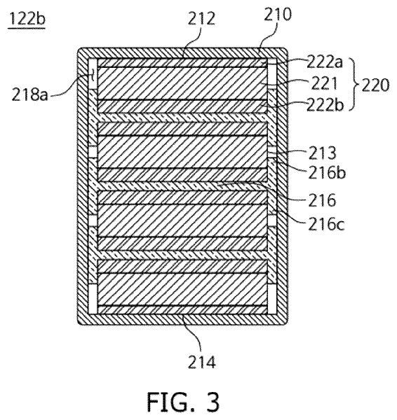

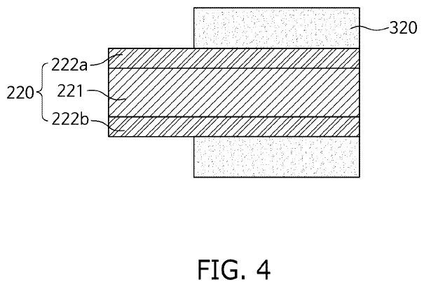

FIG. 2 illustrates an electrode tab using a conductive tape as a conductive layer according to an embodiment of the present disclosure, and FIG. 3 illustrates an electrode tab using a conductive paste as a conductive layer according to an embodiment of the present disclosure. FIG. 4 schematically illustrates an uncoated region according to an embodiment of the present disclosure.

Referring to FIGS. 2 to 4, in the secondary battery 100 according to one embodiment of the present disclosure, each of electrode tabs 122a and 122b, which are coupled to an end of at least one of the first electrode 114 or the second electrode 116, may include multiple uncoated regions 220 on the electrode plate of the first electrode 114 or the second electrode 116. The uncoated regions 220 does not include a coating layer 320 coated with an active material. In other words, the multiple uncoated regions 220 are stacked in a vertical direction. These electrode tabs 122a and 122b may be located on the exterior or interior of the secondary battery case 112, or the electrode tabs 122a and 122b may span the exterior and interior.

In one embodiment, each of the multiple uncoated regions 220 may include an insulating layer 221. The multiple uncoated regions 220 also include a metal layer 222a and/or a metal layer 222b disposed on at least one of an upper surface and a lower surface of the insulating layer 221. For example, each of the multiple uncoated regions 220 may include the insulating layer 221 and the metal layers 222a and 222b on the upper and lower surfaces of the insulating layer 221, respectively. In another example, each of some of the multiple uncoated regions 220 may include the insulating layer 221 and the metal layers 222a and 222b on both the upper surface and the lower surface of the insulating layer 221, while the other uncoated regions 220 may include the insulating layer 221 and the metal layer 222a or 222b on only one of the upper surface and the lower surface of the insulating layer 221.

Referring to FIGS. 2 and 3, the electrode tab 122 may be either a positive electrode tab or a negative electrode tab, and each electrode tab 122 may include the multiple uncoated regions 220 that are stacked vertically, conductive layers 216 disposed between the stacked multiple uncoated regions 220, and a conductive strip member 210 that surrounds the stacked multiple uncoated regions 220 and the conductive layers 216, with the conductive strip member 210 being electrically connected to the conductive layers 216. The conductive layer 216 may not be disposed on an upper surface of the uppermost uncoated region and a lower surface of the lowermost uncoated region.

Each conductive layer 216 may include at least one of protrusions 216a, 216b, and 216c that extend beyond side surfaces 213 of the adjacent uncoated regions 220, with the protrusions 216a, 216b, and 216c contacting the conductive strip member 210. The protrusions 216a, 216b, and 216c of the conductive layers 216 disposed between the uncoated regions 220 may contact an inner side of the conductive strip member 210 such that the conductive layers 216 are in contact with and electrically connected to the conductive strip member 210 to facilitate electrical conduction between the multiple uncoated regions 220 (i.e., between the metal layers of the multiple uncoated regions).

In the electrode tab 122a or 122b according to an embodiment of the present disclosure, the protrusion 216a′ or 216b′ of the conductive layer may cover a side surface 213 of at least one of an adjacent upper uncoated region and the adjacent lower uncoated region.

As shown in the example of FIG. 2, in a case where each of the conductive layers 216 of the electrode tab 122a is formed of a conductive tape, the protrusion 216a of the corresponding conductive layer 216 may be bent in either an upward or downward direction to cover either an upper uncoated region or a lower uncoated region between the uncoated regions that are adjacent to the corresponding conductive layer 216 during the process of contacting the conductive strip member 210. FIG. 2 illustrates an electrode tab in which the multiple protrusions 216a of the conductive tapes are all bent downward, but in other embodiments the multiple protrusions 216a are bent randomly either upward or downward when coming into contact with the conductive strip member 210.

In a case where the conductive layer 216 is formed of the conductive tape, the total width of the conductive tape including the protrusion 216a may be greater than the width of the uncoated region 220.

The conductive tape may be subjected to a pressing process after being attached between the two uncoated regions 220. However, the thickness of the conductive tape may not be significantly reduced by such a pressing process, and, thus, the thickness of the protrusion 216a of the conductive tape and the thickness of the conductive layer 216 of the conductive tape located between the two uncoated regions 220 may be substantially the same.

Alternatively or optionally, as shown in the example of FIG. 3, each of the conductive layers 216 of the electrode tab 122b according to one embodiment of the present disclosure may be formed of a conductive paste. The conductive paste may be disposed in such a way that the conductive paste is applied between two adjacent uncoated regions 220. After the conductive paste is applied as the conductive layer 216, a certain pressure may be applied to at least one of an upper surface of a first uncoated region 212, which is the uppermost uncoated region among the multiple uncoated regions 220 and to a lower surface of a second uncoated region 214, which is the lowermost uncoated region among the multiple uncoated regions 220. When such a pressure is applied, the conductive paste may be squeezed such that the thickness of the conductive paste becomes less than the thickness when it is initially applied, thereby forming the protrusions 216b and 216c extending beyond the side surfaces 213 of the two adjacent uncoated regions 220.

Therefore, the thickness of the conductive layer 216 formed of the conductive paste disposed between the two adjacent uncoated regions 220 and the thickness of the protrusions 216b and 216c each formed of the conductive paste may be different from each other. However, as pressure is applied to the conductive paste in the process of contacting the conductive strip member 210, the thickness of the conductive paste located between the two adjacent uncoated regions 220 and the thickness of the protrusions 216b and 216c of the conductive paste may become substantially the same, but the present disclosure is not limited to such a configuration.

The protrusions 216b and 216c of the conductive layer 216 formed of the conductive paste may be simultaneously bent upwardly and downwardly to cover a side surface of the adjacent upper uncoated region 220 and a side surface of the adjacent lower uncoated region during the process of applying pressure to the uncoated regions between the uppermost and lowermost uncoated regions and contacting the conductive strip member 210 as described above. While FIG. 3 shows the multiple protrusions 216b and 216c of the conductive layer 216 formed of the conductive paste extending a certain distance upward and downward, the protrusions 216b and 216c do not necessarily need to extend the certain distance and may extend randomly as a result of the pressing process and the contact process with the conductive strip member 210.

Since the conductive paste may be applied in a solvent state between the uncoated regions and then hardened, it may come into contact with the electrolyte after the electrolyte is introduced during the manufacturing process of the secondary battery 100. Therefore, the conductive paste may have a property that prevents the conductive paste from dissolving in the electrolyte once it has hardened. For example, the conductive paste may include a paste including at least one metal material selected from silver (Ag), nickel (Ni), palladium (Pd), platinum (Pt), gold (Au), copper (Cu), ruthenium (Ru), rhodium (Rh), osmium (Os), iridium (Ir), aluminum (Al), and tungsten (W).

The electrode tab 122 according to one embodiment of the present disclosure may further include an air gap in a space bounded by the inner side of the conductive strip member 210, the uncoated region 220, and the protrusion 216a or the protrusions 216b and 216c of the conductive layer 216. In the example of FIG. 2, the air gap 218 is surrounded by the inner side of the conductive strip member 210, the uncoated region 220, and the protrusion 216a of the conductive tape. In the example of FIG. 3, the air gap 218a is surrounded by the inner side of the conductive strip member 210, the uncoated region 220, and the protrusions 216b and 216c of the conductive paste.

As shown in FIG. 4, each uncoated region 220 may include the insulating layer 221, the metal layer 222a disposed on the upper surface of the insulating layer 221, and the metal layer 222b disposed on the lower surface of the insulating layer 221. Each uncoated region 220 may extend longitudinally to be disposed between the active material coating layers 320 at one end. The multiple uncoated regions 220 may be vertically stacked at the other end and extend to outside of the case of the secondary battery 100, as shown in FIG. 1.

In the pouch secondary battery 100 according to one embodiment of the present disclosure, the thickness of the negative-electrode uncoated region 220 may be approximately 6 μm while the thickness of the positive-electrode uncoated region 220 may be approximately 10 μm. Thus, the positive-electrode uncoated region 220 may be greater in thickness than the negative-electrode uncoated region 220. Here, the thickness refers to the total thickness including the insulating layer 221 and the metal layers 222a and 222b of the uncoated region, and does not include the active material coating layer 320. While the thickness of the substrate can be varied, it is desirable for the thickness of each uncoated region 220 to be less than 20 μm to enhance the energy density of the battery cell. In general, approximately 15 to 30 sheets of uncoated regions 220 may be overlapped to form the electrode tab 122.

As described above, the conductive strip member 210 may be made of a material that can achieve the purpose of electrical conduction with the metal layers 222a and 222b of the uncoated region and the conductive layer 216. Preferably, the conductive strip member 210 may be a conductive tape or a metal strip.

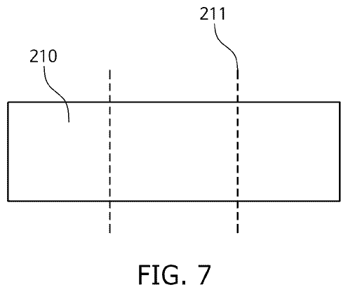

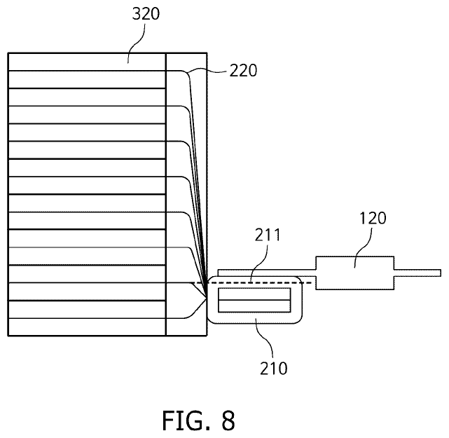

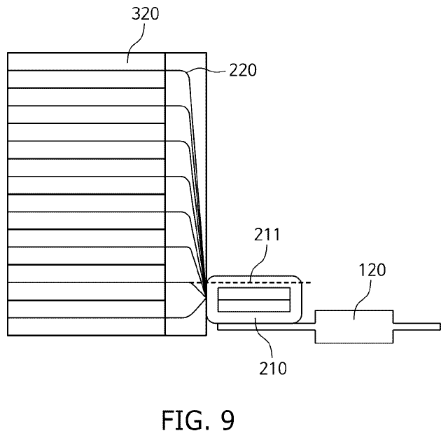

FIG. 7 illustrates a conductive strip member before folding according to an embodiment of the present disclosure. FIG. 8 illustrates a state where a strip terminal is connected to an upper surface of the conductive strip member according to an embodiment of the present disclosure. FIG. 9 illustrates a state where a strip terminal is connected to a lower surface of the conductive strip member according to an embodiment of the present disclosure.

The conductive strip member 210 according to one embodiment of the present disclosure may have a pre-folding structure as shown in FIG. 7. In the pre-folding structure, an overlapping portion of the conductive strip member 210 when folded downwards along folding lines 211 may become the lower surface, and a portion (approximately 9 mm) of the conductive strip member 210 between the folding lines 211 may become the upper surface. Since the conductive strip member has a relatively small thickness, it may be advantageous in terms of stability to manufacture the conductive strip member in a manner such that the conductive strip member is folded along the folding lines and the folded portions overlap at the bottom. Therefore, the upper surface of the conductive strip member 210 may be a single layer and the lower surface may be a double layer. However, it is also possible to form the conductive strip member 210 in multiple layers.

After the conductive strip member 210 is folded to enclose the stacked multiple uncoated regions 220, a strip terminal 120 may be connected to either the upper surface of the folded conductive strip member 210 as shown in FIG. 8 or to the lower surface of the folded conductive strip member 210 as shown in FIG. 9. When the strip terminal 120 is connected to the lower surface as shown in FIG. 9, the strip terminal 120 may be connected to at least one of the overlapping surfaces of the folded conductive strip member 210. The connection method may be welding, preferably ultrasonic welding or laser welding.

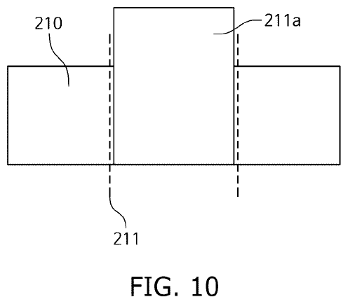

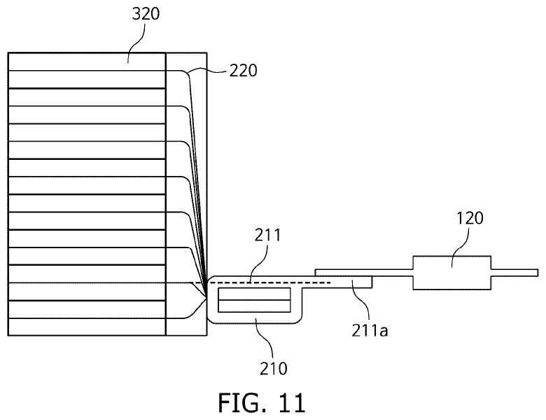

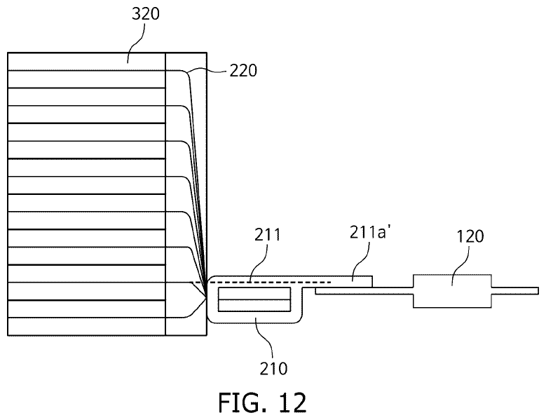

FIG. 10 illustrates a conductive strip member including a body portion and a connection portion before folding according to another embodiment of the present disclosure. FIG. 11 illustrates a state where a strip terminal is connected to an upper surface of the connection portion of the conductive strip member according to an embodiment of the present disclosure, and FIG. 12 illustrates a state where a strip terminal is connected to a lower surface of the connection portion of the conductive strip member according to an embodiment of the present disclosure.

The conductive strip member 210 according to another embodiment of the present disclosure may have a pre-folding structure as shown in FIG. 10. In the pre-folding structure, the conductive strip member 210 may include a body portion that surrounds the multiple uncoated regions 220 and the conductive layer, and the conductive strip member 210 may also include a connection portion 211a extending from the body portion. After the conductive strip member 210 is folded to enclose the stacked multiple uncoated regions 220, a strip terminal 120 may be connected to either the upper surface of the connection portion 211a as shown in FIG. 11 or the lower surface of the connection portion 211a′ as shown in FIG. 12. The strip terminal 120 may be connected to the conductive strip member 210 by, for example, ultrasonic welding or laser welding.

In a case where the conductive strip member 210 is an adhesive conductive tape, the overlapping lower surfaces may be attached to each other. However, in a case where the conductive strip member 210 is a non-adhesive metal strip, a separate welding to connect the lower surfaces may be required. Therefore, in some embodiments, it may be advantageous to weld the strip terminal 120 to the lower surface of the conductive strip member 210 or the lower surface of the connection portion 211a′ to avoid an additional welding process.

As the conductive strip member 210 adheres to the conductive layers 216, the stacked multiple uncoated regions may be fixed. Thus, the conductive strip member 210 may not be completely bonded at its overlapping lower surfaces but the conductive strip member 210 remains fixed because of the adhesion of the conductive strip member 210 to the conductive layers 216.

Hereinafter, a method for manufacturing the electrode tab according to various embodiments of the present disclosure will be described.

### First Embodiment

First, multiple uncoated regions 220 may be stacked in a vertical direction. Preferably, about 15 to 30 sheets of uncoated regions may be stacked. At this time, a conductive tape, which serves as the conductive layer 216, may be attached between each of two adjacent uncoated regions 220. That is, the uncoated regions 220 and the conductive tape can be alternately stacked.

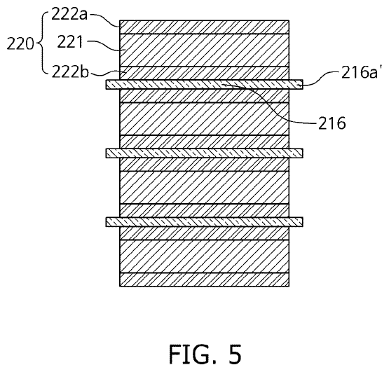

FIG. 5 is a diagram illustrating stacked multiple uncoated regions with a conductive tape disposed between each of two adjacent uncoated regions according to one embodiment of the present disclosure.

The conductive tape, which serves the conductive layer 216, may be configured to protrude outwardly from (extend beyond) the side surface 213 of the uncoated regions to facilitate electrical conduction with the conductive strip member 210.

Thereafter, a pressing process may be carried out to ensure the multiple conductive tapes are firmly attached. After placing, for example, the conductive strip member 210 shown in FIG. 7 on the upper surface of the uppermost uncoated region 212 of the stacked structure in which the multiple uncoated regions 220 are stacked in a vertical direction, the conductive strip member 210 is folded downward to wrap around (surround) the stacked structure. During this process, a protrusion 216a′ of the conductive tape may be compressed by the inner side of the conductive strip member 210, thereby causing the protrusion 216a′ to bend either towards the side surface 213 of the adjacent upper uncoated region or the side surface 213 of the adjacent lower uncoated region.

The distance of the gap between the folding lines 211 of the conductive strip member 210 is based on the size of the multiple uncoated regions surrounded by the conductive tape. The overlapping portion of the folded conductive strip member 210 may be fixed when the conductive strip member 210 is adhesive. Subsequently, a process of electrically connecting the upper or lower surface of the conductive strip member 210 to the strip terminal 120 through a welding process may be performed.

As another example, in the case of the conductive strip member 210 shown in FIG. 10, the assembled structure may include the body portion and the connecting portion 211a or 211a′. Therefore, a process of electrically connecting the upper or lower surface of the connecting portion 211a or 211a′ to the strip terminal 120 through a welding process may be performed.

### Second Embodiment

For convenience of, differences from the manufacturing method of the first embodiment will be mainly described.

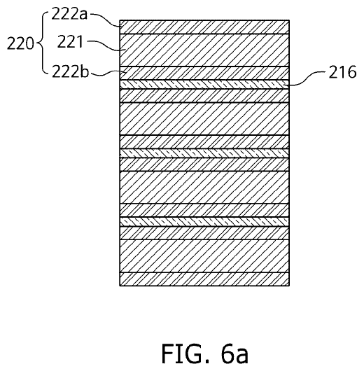

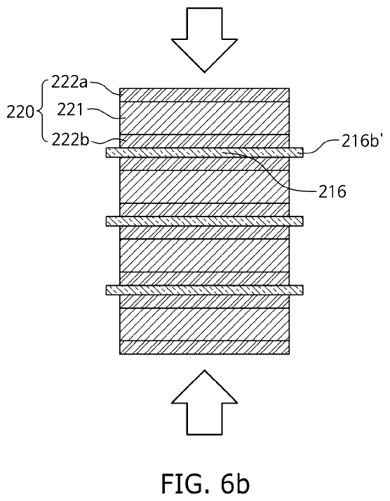

FIG. 6a illustrates stacked multiple uncoated regions with a conductive paste applied between each of two adjacent uncoated regions according to an embodiment of the present disclosure. FIG. 6b illustrates the result of pressing the uncoated regions after the conductive paste is applied between each of two adjacent uncoated regions of the stacked multiple uncoated regions according to an embodiment of the present disclosure.

As shown in FIG. 6a, the conductive paste, which serves as the conductive layer 216, may be applied between each of two adjacent uncoated regions of the stacked multiple uncoated regions 220 such that the conductive tape and the uncoated regions are alternatively stacked. Next, as shown in FIG. 6b, a pressing process may be performed to spread the conductive paste by applying pressure to at least one of the upper surface of the first uncoated region 212 disposed at the uppermost position of the multiple uncoated regions and the lower surface of the second uncoated region 214 disposed at the lowermost position of the multiple uncoated regions. As a result, the conductive pastes protrude to outside of the side surfaces 213 of the uncoated regions, thereby forming protrusions 216b′.

Thereafter, the conductive strip member 210 shown in FIG. 7 may be placed on the upper surface of the uppermost uncoated region 212 of the stacked structure in which the multiple uncoated regions 220 are stacked in the vertical direction. Then, the conductive strip member 210 may be folded downward to surround the stacked structure. During the folding process, as the inner side of the conductive strip member 210 compresses the protrusions 216b′ of the conductive paste, the protrusions 216b′ may extend in the direction along the side surfaces of the adjacent upper uncoated region 220 and the adjacent lower uncoated region 220, thereby forming protrusions 216b and 216c.

The present disclosure may provide the electrode assembly 110 in which the electrode tab 122 is coupled to one end of the first electrode 114 or the second electrode 116. Specifically, the electrode assembly 110 may include the first electrode 114, the second electrode 116, the separator 118 disposed between the first electrode 114 and the second electrode 116, and the electrode tab 122 coupled to one end of the first electrode 114. The electrode tab 122 may include multiple uncoated regions 220 stacked in the vertical direction, with each of the uncoated regions 220 including the insulating layer 221 and a metal layer 222a and/or 222b disposed on at least one of the upper surface and the lower surface of the insulating layer 221; a conductive layer 216 disposed between each of two adjacent uncoated regions of the multiple uncoated regions 220; and a conductive strip member 210 surrounding the stacked multiple uncoated regions 220 and the conductive layers 216 to be electrically connected to the conductive layers 216.

Additionally, the present disclosure may provide a secondary battery that includes the above-described electrode tab 122. Specifically, the secondary battery 100 may include the electrode assembly 110, the case 112 enclosing the electrode assembly, and an electrolyte impregnating the electrode assembly. Further, the electrode assembly 110 may include the first electrode 114, the second electrode 116, the separator 118 disposed between the first electrode 114 and the second electrode 116, and the electrode tab 122 coupled to one end of the first electrode 114. Here, the electrode tab 122 may include multiple uncoated regions 220 stacked in the vertical direction, each including the insulating layer 221 and a metal layer 222a and/or 222b disposed on at least one of the upper surface and the lower surface of the insulating layer 221; a conductive layer 216 disposed between each of two adjacent uncoated regions of the multiple uncoated regions 220; and a conductive strip member 210 surrounding the stacked multiple uncoated regions 220 and the conductive layers 216 to be electrically connected to the conductive layers 216.

Although the present disclosure has been described above with respect to embodiments thereof, the present disclosure is not limited thereto. Various modifications and variations can be made thereto by those skilled in the art within the spirit of the present disclosure.

Explanation of reference symbols

100: secondary battery
110: electrode assembly
112: case
120, 123: strip terminal
122, 122a, 122b, 124: electrode tab
114: first electrode
116: second electrode
118: separator
125: insulating portion
210: conductive strip member
211: folding line
211a, 211a′: connection portion of conductive strip member
212: first uncoated region
213: side surface of uncoated region
214: second uncoated region
216: conductive layer
216a: lower protrusion of conductive tape
216a′: protrusion of conductive tape
216b: upper protrusion of conductive tape
216b′: protrusion of conductive paste
216c: lower protrusion of conductive tape
218: air gap
218a: air gap
220: uncoated region
221: insulating layer
222a, 222b: metal layer
320: active material coating layer

What is claimed is:

1. An electrode tab comprising:
uncoated regions stacked in a vertical direction, each of the uncoated regions including an insulating layer and a metal layer disposed on at least one of an upper surface and a lower surface of the insulating layer;
a conductive layer disposed between each two adjacent uncoated regions of the uncoated regions; and
a conductive strip member that surrounds the stacked uncoated regions and the conductive layer, with the conductive strip member being electrically connected to the conductive layer.

2. The electrode tab as claimed in claim 1, wherein the conductive layer comprises a protrusion extending beyond a side surface of an adjacent uncoated region, with the protrusion contacting the conductive strip member.

3. The electrode tab as claimed in claim 2, wherein the protrusion covers at least one side surface of an adjacent upper uncoated region and an adjacent lower uncoated region.

4. The electrode tab as claimed in claim 1, wherein the conductive layer comprises a conductive tape.

5. The electrode tab as claimed in claim 1, wherein the conductive layer comprises a conductive paste.

6. The electrode tab as claimed in claim 2, wherein the conductive strip member is in contact with an upper surface of a first uncoated region disposed at the uppermost position of the multiple uncoated regions, a lower surface of a second uncoated region disposed at the lowermost position of the multiple uncoated regions, and the protrusion of the conductive layer.

7. The electrode tab as claimed in claim 1, further comprising a strip terminal coupled to an upper surface or a lower surface of the conductive strip member.

8. The electrode tab as claimed in claim 1, wherein the conductive strip member comprises (i) a body portion that surrounds the uncoated regions and the conductive layer and (ii) a connection portion extending from the body portion.

9. The electrode tab as claimed in claim 8, further comprising a strip terminal coupled to an upper surface or a lower surface of the connection portion.

10. The electrode tab as claimed in claim 2, further comprising an air gap surrounded by an inner side of the conductive strip member, an uncoated region of the uncoated regions, and the protrusion.

11. An electrode assembly comprising:
a first electrode;
a second electrode;
a separator disposed between the first electrode and the second electrode; and
an electrode tab coupled to one end of the first electrode,
wherein the electrode tab comprises:
uncoated regions stacked in a vertical direction, each of the uncoated regions including an insulating layer and a metal layer disposed on at least one of an upper surface and a lower surface of the insulating layer;
a conductive layer disposed between each of two adjacent uncoated regions of the uncoated regions; and
a conductive strip member that surrounds the stacked uncoated regions and the conductive layer, with the conductive strip member being electrically connected to the conductive layer.

12. The electrode assembly as claimed in claim 11, wherein the conductive layer comprises a protrusion extending beyond a side surface of an adjacent uncoated region, with the protrusion contacting the conductive strip member.

13. The electrode assembly as claimed in claim 12, wherein the protrusion covers at least one side surface of an adjacent upper uncoated region and an adjacent lower uncoated region.

14. The electrode assembly as claimed in claim 11, wherein the conductive layer comprises a conductive tape.

15. The electrode assembly as claimed in claim 11, wherein the conductive layer comprises a conductive paste.

16. The electrode assembly as claimed in claim 12, wherein the conductive strip member is in contact with an upper surface of a first uncoated region disposed at the uppermost position of the multiple uncoated regions, a lower surface of a second uncoated region disposed at the lowermost position of the multiple uncoated regions, and the protrusion of the conductive layer.

17. A secondary battery comprising:
an electrode assembly;
a case enclosing the electrode assembly; and
an electrolyte impregnating the electrode assembly,
wherein the electrode assembly comprises:
a first electrode;
a second electrode;
a separator disposed between the first electrode and the second electrode; and
an electrode tab coupled to one end of the first electrode, and
wherein the electrode tab comprises:
uncoated regions stacked in a vertical direction, each of the uncoated regions including an insulating layer and a metal layer disposed on at least one of an upper surface and a lower surface of the insulating layer;
a conductive layer disposed between each of two adjacent uncoated regions of the uncoated regions; and
a conductive strip member that surrounds the stacked uncoated regions and the conductive layer, with the conductive strip member being electrically connected to the conductive layer.

18. The secondary battery as claimed in claim 17, wherein the conductive layer comprises a protrusion extending beyond a side surface of an adjacent uncoated region, with the protrusion contacting the conductive strip member.

19. The secondary battery as claimed in claim 17, wherein the conductive layer comprises a conductive tape or a conductive paste.

20. The secondary battery as claimed in claim 18, wherein the conductive strip member is in contact with an upper surface of a first uncoated region disposed at the uppermost position of the multiple uncoated regions, a lower surface of a second uncoated region disposed at the lowermost position of the multiple uncoated regions, and the protrusion of the conductive layer.
